(19) United States
(12) Patent Application Publication
(10) Pub. No.: US 2018/0030882 A1
(43) Pub. Date: Feb. 1, 2018

(54) COUPLING MECHANISM

(71) Applicant: Caterpillar Inc., Peoria, IL (US)

(72) Inventor: Scott R. Schuricht, Princeville, IL (US)

(73) Assignee: Caterpillar Inc., Peoria, IL (US)

(21) Appl. No.: 15/219,313

(22) Filed: Jul. 26, 2016

(51) Int. Cl. F02B 29/04; F02B 37/00; F01P 3/18; F16M 13/02; F02M 31/20

(52) U.S. Cl. CPC F02B 29/0462; F16M 13/02; F02M 31/20; F01P 3/18; F02B 37/00

(57) ABSTRACT

A coupling mechanism for a tie bar and a side sheet of an aftercooler is provided. The coupling mechanism includes a male portion of a mechanical joint. The male portion is coupled with a tail end of the tie bar. The coupling mechanism also includes a female portion of the mechanical joint defined within the side sheet. The male portion is adapted to mate with the female portion for coupling the tie bar with the side sheet.

### TECHNICAL FIELD

The present disclosure relates to a coupling mechanism, and more particularly to the coupling mechanism for a tie bar and a side sheet of an aftercooler.

### BACKGROUND

Aftercoolers associated with an engine generally include a pair of tie bars. The tie bars are provided between a pair of side sheets of the aftercooler positioned at a top portion and a bottom portion of the aftercooler. The tie bars reduce bowing of the side sheets of the aftercooler due to internal air pressure.

Current aftercooler design utilizes a bolted joint between the side sheet and the tie bar. A sealant is provided in association with the bolted joint between the side sheet and the tie bar in order to prevent gas leakages through bolt threads. In addition to the sealant, a thread locking material is provided around the bolt for retaining clamp load during thermal cycle events. However, this design may be difficult to manufacture consistently and may also lead to increase in manufacturing time and associated costs. Further, the design may not provide a leak proof joint between the tie bar and the side sheet.

U.S. Patent Publication Number 2008/149312 describes a vehicle air conditioning system has a condenser with a header tank attached to it. A modulator attaches to the header tank using a full-length dove tail joint that is further secured and sealed to the header tank by a brazing process. A modulator inlet receives gaseous refrigerant from the condenser and discharges liquid refrigerant to a bottom, sub cooler portion of the condenser. The modulator inlet and outlet pass through the dove tail joint of the modulator and header tank.

### SUMMARY OF THE DISCLOSURE

In one aspect of the present disclosure, a coupling mechanism for a tie bar and a side sheet of an aftercooler is provided. The coupling mechanism includes a male portion of a mechanical joint. The male portion is coupled with a tail end of the tie bar. The coupling mechanism also includes a female portion of the mechanical joint defined within the side sheet. The male portion is adapted to mate with the female portion for coupling the tie bar with the side sheet.

In another aspect of the present disclosure, an aftercooler is associated with an engine. The aftercooler includes a tie bar having a tail end. The aftercooler also includes a side sheet. The aftercooler further includes a coupling mechanism adapted to couple the tie bar with the side sheet. The coupling mechanism includes a male portion of a mechanical joint. The male portion is coupled with a tail end of the tie bar. The coupling mechanism also includes a female portion of the mechanical joint defined within the side sheet. The male portion is adapted to mate with the female portion for coupling the tie bar with the side sheet.

In yet another aspect of the present disclosure, an engine system is provided. The engine system includes an engine. The engine system also includes an aftercooler associated with the engine. The aftercooler includes a tie bar having a tail end. The aftercooler also includes a side sheet. The aftercooler further includes a coupling mechanism adapted to couple the tie bar with the side sheet. The coupling mechanism includes a male portion of a mechanical joint. The male portion is coupled with a tail end of the tie bar. The coupling mechanism also includes a female portion of the mechanical joint defined within the side sheet. The male portion is adapted to mate with the female portion for coupling the tie bar with the side sheet.

Other features and aspects of this disclosure will be apparent from the following description and the accompanying drawings.

### BRIEF DESCRIPTION OF THE DRAWINGS

FIG. 1 is a perspective view of an exemplary engine system having an engine, according to one embodiment of the present disclosure;

FIG. 2 is a perspective view of an aftercooler associated with the engine of FIG. 1;

FIG. 3 is perspective view of a portion of the aftercooler of FIG. 2 showing a coupling mechanism for coupling a tie bar and a side sheet of the aftercooler, according to one embodiment of the present disclosure;

FIG. 4 is a top view of the coupling mechanism showing the tie bar and the male portion of the coupling mechanism formed as separate components, according to another embodiment of the present disclosure;

FIG. 5 is a top view of the coupling mechanism showing the coupling mechanism having a mechanical fastener, according to yet another embodiment of the present disclosure; and

FIG. 6 is a top view of the coupling mechanism showing the male portion of the coupling mechanism having a circular configuration, according to one embodiment of the present disclosure.

### DETAILED DESCRIPTION

Wherever possible, the same reference numbers will be used throughout the drawings to refer to the same or the like parts. Also, corresponding or similar reference numbers will be used throughout the drawings to refer to the same or corresponding parts.

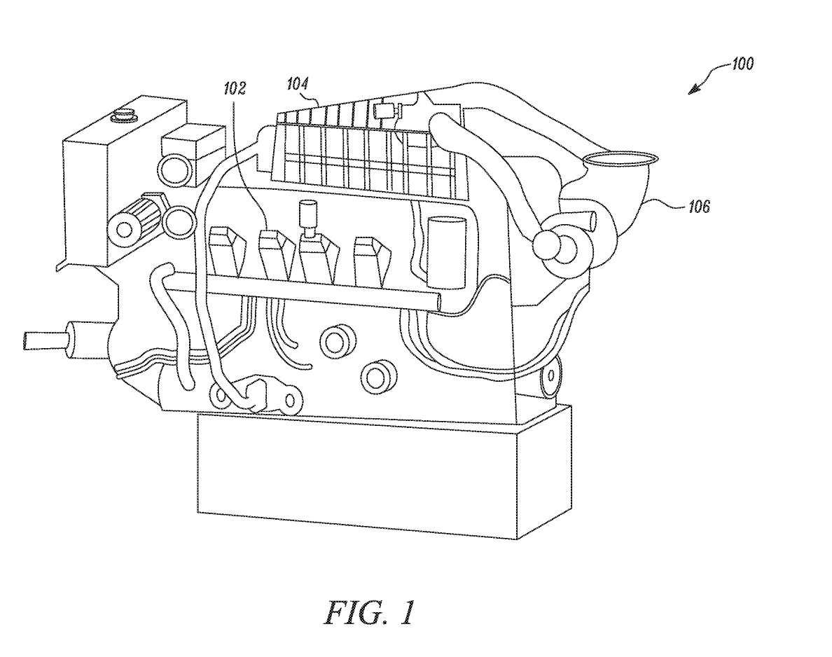

FIG. 1 illustrates a perspective view of an engine system 100. The engine system 100 includes an engine 102. The engine 102 may be an internal combustion engine, such as a reciprocating piston engine. Further, the engine 102 may be a spark ignition engine or a compression ignition engine, such as a diesel engine, a natural gas engine, a homogeneous charge compression ignition engine, a reactivity controlled compression ignition engine, or any other engine known in the art. The engine 102 may be fueled by one or a combination of gasoline, diesel fuel, biodiesel, dimethyl ether, alcohol, natural gas, propane, or any other combustion fuel known in the art.

The engine 102 is a V-type engine. The engine 102 includes eight cylinders (not shown). Alternatively, the engine 102 may embody an inline engine, without limiting the scope of the present disclosure. It should be noted that a number of cylinders associated with the engine 102 may vary based on the type of engine application. A combustion chamber (not shown) is formed within each cylinder of the engine 102. The combustion chamber may receive intake air from an intake manifold (not shown). Further, products of combustion created during combustion within the combustion chamber are let out of the engine 102, via an exhaust manifold (not shown).

The engine 102 may be used to power a machine including, but not limited to, an on-highway truck, an off-highway truck, an earth moving machine, and an electric generator. Further, the engine system 100 may be associated with an industry including, but not limited to, transportation, construction, agriculture, forestry, power generation, and material handling.

The engine 102 includes a turbocharger 104 that increases an efficiency and power output of the engine 102 by forcing extra air into the combustion chamber of the engine 102. The turbocharger 104 is driven by a turbine which is in turn driven by engine exhaust gases. The turbocharger 104 receives uncompressed atmospheric air via an air filter (not shown) of the engine system 100. The turbocharger 104 compresses the air to high pressure intake air. Further, the turbocharger 104 delivers the compressed intake air to an aftercooler 106 associated with the engine 102.

The aftercooler 106 of the engine system 100 is positioned between the turbocharger 104 and the engine 102, with respect to a flow direction of the intake air. The aftercooler 106 is a heat exchanger that reduces heat acquired by the intake air during its compression, and thus increase a quantity of useful oxygen in a given volume of air. Cooled intake air from the aftercooler 106 is introduced in the intake manifold of the engine 102. In the illustrated embodiment, the aftercooler 106 is embodied as an air-to-liquid aftercooler. More particularly, the aftercooler 106 is a water-cooled aftercooler. As shown, the aftercooler 106 is mounted on top of the engine 102. However, a position of the aftercooler 106 may change, based on system requirements.

The engine system 100 includes an exhaust system (not shown). The exhaust system treats exhaust gases exiting from the exhaust manifold of the engine 102. The exhaust system may trap or convert Nitrogen Oxides (NOx), Unburned Hydrocarbons (UHC), particulate matter, or its combinations, or other combustion products in the exhaust gases before exiting the engine system 100.

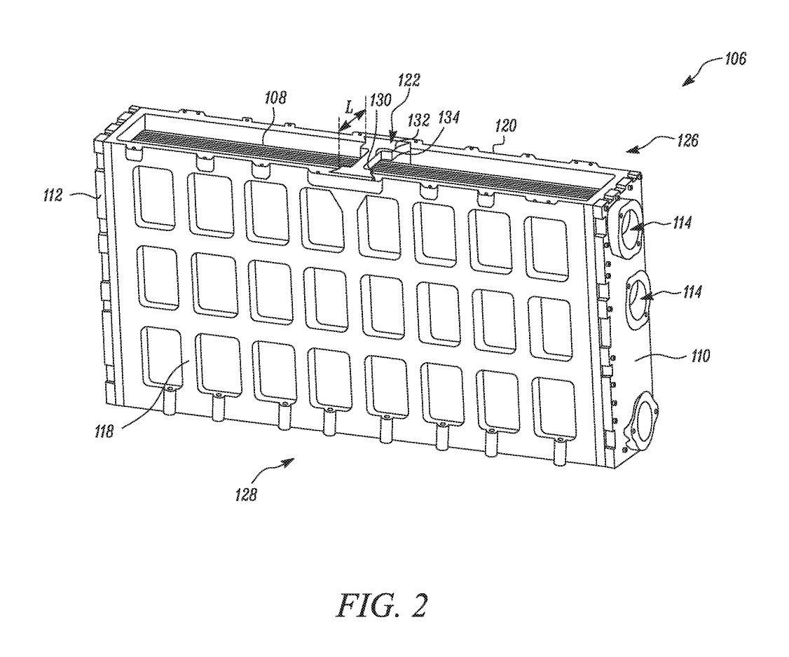

Referring now to FIG. 2, a perspective view of the aftercooler 106 is shown. The aftercooler 106 includes a number of cooling tubes 108. In operation, cooling water flows through the cooling tubes 108, whereas, intake air flows over the cooling tubes 108. The cooling water exchanges heat with the intake air flowing over the cooling tubes 108, thereby lowering a temperature of the intake air.

The aftercooler 106 includes a first water tank 110 and a second water tank 112. The first water tank 110 introduces cooling water into the cooling tubes 108. The first water tank 110 includes openings 114 that allow fluid communication between the first water tank 110 and an engine cooling system (not shown). The first water tank 110 receives the cooling water from the engine cooling system.

Further, the second water tank 112 of the aftercooler 106 also includes openings (not shown). The openings allow the cooling water to exit the aftercooler 106. The openings of the second water tank 112 may be in fluid communication with the engine cooling system. The cooling water exiting the aftercooler 106 flows towards the engine cooling system for removing heat therefrom.

The aftercooler 106 also includes a first side sheet 118 and a second side sheet 120. The first side sheet 118, the second side sheet 120, the first water tank 110, and the second water tank 112 enclose the cooling tubes 108. The first and second side sheets 118, 120 allow mounting of the aftercooler 106 to a housing of the engine 102. The first and second side sheets 118, 120 resist internal air pressure/deflection experienced by the aftercooler 106. The first and second side sheets 118, 120 are rectangular in shape. Further, a length of the first and second side sheets 118, 120 is approximately equal to a length of the cooling tubes 108.

The aftercooler 106 includes a first tie bar 122 and a second tie bar (not shown). It should be noted that the aftercooler 106 may include more than two tie bars, without any limitations. A total number of the tie bars associated with the aftercooler 106 may vary based on the length of the cooling tubes 108 or a size of the aftercooler 106. The first tie bar 122 and the second tie bar reduces bowing of the side sheets 118, 120 due to internal air pressure. As shown in the accompanying figures, the first tie bar 122 is provided at a top portion 126 of the aftercooler 106. The second tie bar may be provided at a bottom portion 128 of the aftercooler 106. Each of the first tie bar 122 and the second tie bar extend between the first and second side sheets 118, 120 at the top and bottom portions 126, 128 of the aftercooler 106 respectively. A length “L” of each of the first tie bar 122 and the second tie bar is equal to a distance between the first and second side sheets 118, 120.

A design of the tie bar will now be explained in detail with reference to the first tie bar 122. However, it should be noted that the details of the first tie bar 122 disclosed herein are equally applicable to the second tie bar, or any other tie bar associated with the aftercooler 106, without any limitations. The first tie bar 122 includes a first tail end 130 and a second tail end 132. The first tail end 130 of the first tie bar 122 couples with the first side sheet 118. Whereas, the second tail end 132 of the first tie bar 122 couples with the second side sheet 120. Further, the first tie bar 122 includes a bar member 134 extending between the first and second tail ends 130, 132. The bar member 134 has a rectangular cross-section.

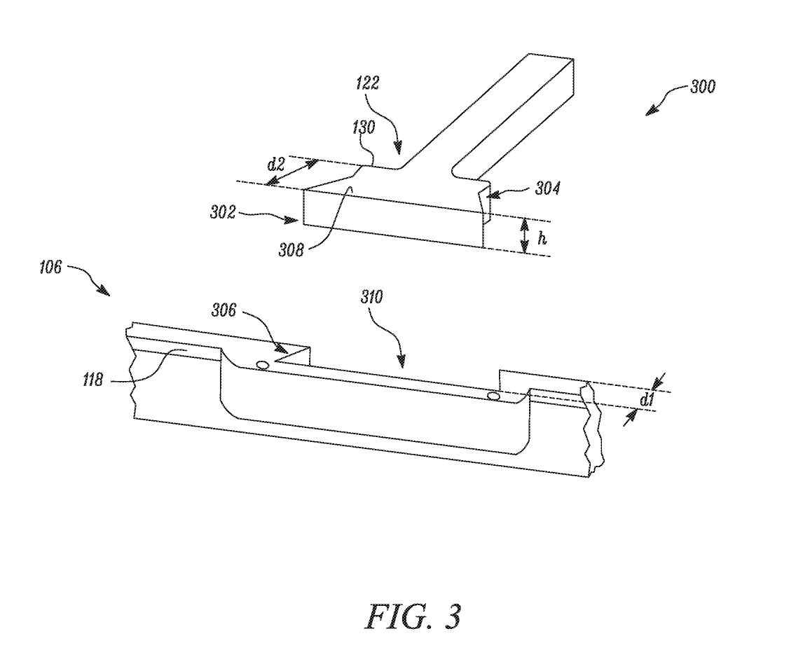

Each of the first tie bar 122 and the second tie bar are coupled to the first and second side sheets 118, 120 using a coupling mechanism 300 (see FIG. 3). Referring to FIG. 3, the coupling mechanism 300 for coupling the first tail end 130 of the first tie bar 122 with the first side sheet 118 will now be described in detail. It should be noted that the coupling mechanism 300 can also be used to couple the second tail end 132 of the first tie bar 122 with the second side sheet 120, a first tail end of the second tie bar with the first side sheet 118, and a second tail end of the second tie bar with the second side sheet 120, without any limitations.

As shown in the accompanying figures, the coupling mechanism 300 includes a mechanical joint 302. In one example, the mechanical joint 302 is a dovetail joint, and more particularly, a half-blind dovetail joint. Alternatively, the mechanical joint 302 may be embodied as any other type of mechanical joint that creates tortious path for the air and allows coupling of the first tail end 130 with the first side sheet 118, without limiting the scope of the present disclosure.

The mechanical joint 302 includes a male portion 304 and a female portion 306. The male portion 304 of the mechanical joint 302 is coupled with the first tail end 130 of the first tie bar 122 and projects therefrom. The male portion 304 includes a projecting portion 308. In the illustrated embodiment, the male portion 304 of the mechanical joint 302 has a trapezoidal shape extending from the first tail end 130 of the first tie bar 122. Further, the male portion 304 of the mechanical joint 302 and the first tie bar 122 are formed as a unitary component. The male portion 304 and the first tie bar 122 may be formed by molding, casting, or any other forming process known in the art.

Further, the mechanical joint 302 includes the female portion 306. The female portion 306 is defined within the first side sheet 118. During the coupling of the first tie bar 122 and the first side sheet 118, the male portion 304 of the mechanical joint 302 mates with the female portion 306. In one example, the female portion 306 is a socket 310 that is formed within the first side sheet 118. The socket 310 corresponds to the projecting portion 308 of the male portion 304 in terms of shape and size, such that the male and female portions 304, 306 of the mechanical joint 302 mate within the first side sheet 118 to couple the first tail end 130 with the first side sheet 118. In the illustrated example, the socket 310 is trapezoidal in shape. Further, a height (not shown) and a depth “d1” of the socket 310 may be approximately equal to a height “h” and a depth “d2” of the projecting portion 308.

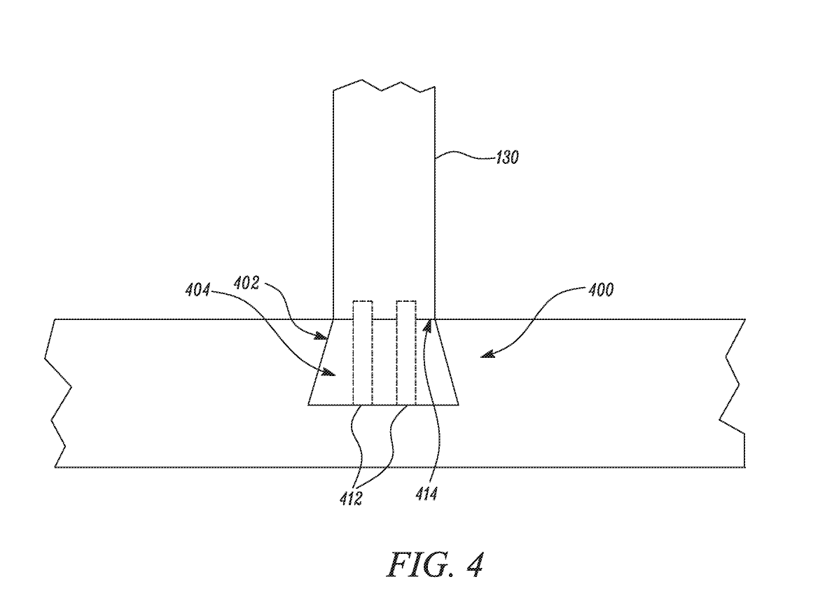

FIG. 4 illustrates another embodiment of the coupling mechanism 400. In this embodiment, the male portion 404 of the mechanical joint 402 and the first tail end 130 are formed as separate units that are coupled using a mechanical joining technique known in the art. As shown in the accompanying figures, a pair of mechanical fasteners 412 may be used to couple the male portion 404 with the first tail end 130. Alternatively, a single mechanical fastener may also be used to couple the male portion 404 with the first tail end 130. The mechanical fasteners 412 may include, but is not limited to, a bolt, a screw, a rivet, and a pin. In another example, the male portion 404 may be welded to the first tail end 130 at an outer periphery 414 of the first tail end 130. Further, any joining process such as brazing or soldering may also be used to couple the male portion 404 with the first tail end 130. It should be noted that other design details of the coupling mechanism 400 are similar that of the coupling mechanism 300 described in connection with FIG. 3.

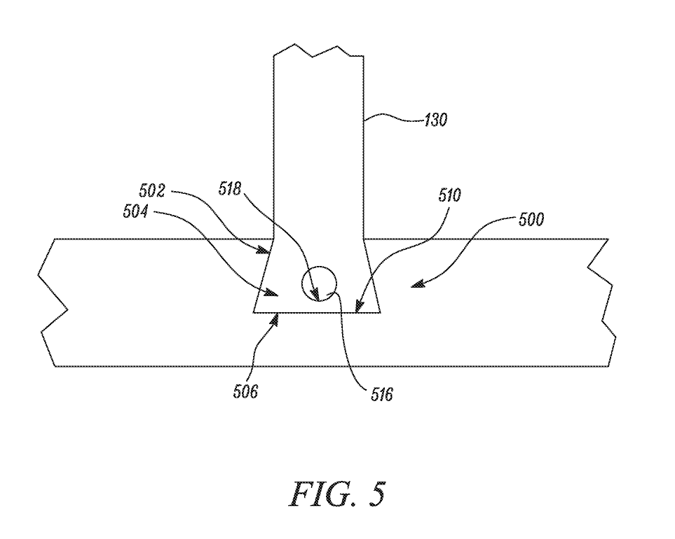

FIG. 5 illustrates yet another embodiment of the present disclosure. In this embodiment, the coupling mechanism 500 includes a mechanical fastener 516. The mechanical fastener 516 attaches the male portion 504 of the mechanical joint 502 within the socket 510 of the female portion 506. More particularly, the mechanical fastener 516 ensures further locking of the male portion 504 with the female portion 506 so that the male and female portions 504, 506 may not decouple easily during aftercooler operation.

The mechanical fastener 516 extends perpendicular to the length “L” of the first tie bar 122. The male portion 504 of the mechanical joint 502 includes a through hole 518 that extends perpendicular to the length “L” of the first tie bar 122. The through hole 518 of the first tie bar 122 is in communication with the socket 510 of the female portion 506. Further, the first side sheet 118 includes a blind hole (not shown) that extends perpendicular to the length “L” of the first tie bar 122. The blind hole is in communication with the socket 510. The through hole 518 and the blind hole are aligned with each other to receive the mechanical fastener 516 for attaching the male portion 504 within the socket 510 of the female portion 506, thereby coupling the first tail end 130 of the first tie bar 122 and the first side sheet 118.

The mechanical fastener 516 may include any one of a bolt, a screw, a rivet, a dowel pin, and the like. The mechanical fastener 516 may have a screw connection or may be press fitted for attaching the male portion 504 within the socket 510 of the female portion 506. In this embodiment, the male portion 504 and the first tail end 130 are manufactured as a unitary component. Alternatively, the male portion 504 and the first tie bar 122 may be formed as separate components that can be coupled using any joining processes known in the art. It should be noted that other design details of the coupling mechanism 500 are similar to that of the coupling mechanism 300 described in connection with FIG. 3.

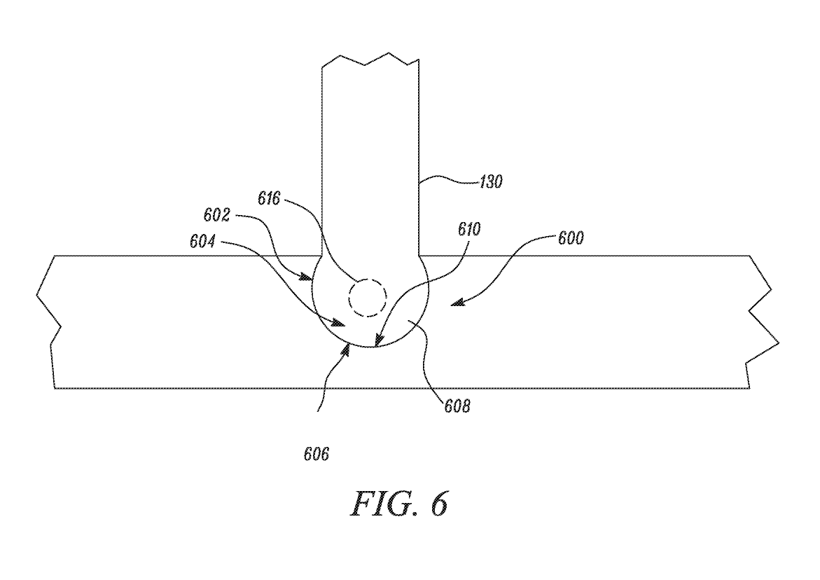

Referring now to FIG. 6, another design of the coupling mechanism 600 is illustrated. In this design, the male portion 604 of the mechanical joint 602 includes the projecting portion 608 having a circular shape extending from the first tail end 130 of the first tie bar 122. The male portion 604 and the first tie bar 122 are formed as a unitary component. Alternatively, the male portion 604 and the first tie bar 122 may be formed as separate components that are coupled using any known joining technique known in the art. In the illustrated embodiment, the socket 610 formed within the first side sheet 118 has a circular cross-section, such that the male and female portions 604, 606 of the mechanical joint 602 are adapted to mate within the first side sheet 118 to couple the first tie bar 122 with the first side sheet 118.

It should be noted that the projecting portion 608 may include any other shape that allows mating of the male and female portions 604, 606 of the mechanical joint 602, without limiting the scope of the present disclosure. The coupling mechanism 600 also include the mechanical fastener 616 similar to the mechanical fastener 516 described in connection with FIG. 6 to ensure further interlocking of the male and female portions 604, 606. It should be noted that other design details of the coupling mechanism 600 are similar to that described in connection with the coupling mechanism 300 of FIG. 3.

### INDUSTRIAL APPLICABILITY

The present disclosure relates to the coupling mechanism for attaching each of the first tie bar 122 and the second tie bar of the aftercooler 106 with the first and second side sheets 118, 120. For explanatory purposes, this section will now be explained in reference to the coupling mechanism 300 that is used to couple the first tail end 130 of the first tie bar 122 with the first side sheet 118. The coupling mechanism 300 eliminates usage of bolts that are driven through the first side sheet 118 and the first tail end 130 to attach the first side sheet 118 with the first tie bar 122. Instead, the coupling mechanism 300 includes the male portion 304 that sealingly engages and interlocks with the female portion 306 in order to couple the first tie bar 122 with the first side sheet 118. Thus, the coupling mechanism 300 eliminates a leak path that exists through bolt threads towards the outside environment.

Further, the coupling mechanism 300 eliminates requirements of sealants or any additional thread locking material, thereby reducing overall manufacturing cost of the aftercooler 106 and also reducing assembly time of the aftercooler 106. The coupling mechanism 300 includes fewer components that are easy to manufacture and also provides an easy coupling method. Also, the coupling mechanism 300 eliminates the requirement of skilled labor for coupling the first tie bar 122 with the first side sheet 118. It should be noted that the description provided herein is equally applicable to the other coupling mechanisms 400, 500, 600 that are illustrated in FIGS. 4, 5, and 6 respectively, without limiting the scope of the present disclosure.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

1. A coupling mechanism for a tie bar and a side sheet of an aftercooler, the coupling mechanism comprising:
a male portion of a mechanical joint, the male portion coupled with a tail end of the tie bar; and
a female portion of the mechanical joint defined within the side sheet,
wherein the male portion is adapted to mate with the female portion for coupling the tie bar with the side sheet.

2. The coupling mechanism of claim 1, wherein the mechanical joint is a dovetail joint.

3. The coupling mechanism of claim 2, wherein the mechanical joint is a half blind dovetail joint such that the male portion includes a projecting portion and the female portion includes a socket corresponding to the projecting portion.

4. The coupling mechanism of claim 1, wherein the male portion of the mechanical joint has at least one of a trapezoidal shape and a circular shape extending from the tail end of the tie bar.

5. The coupling mechanism of claim 1, wherein female portion formed within the side sheet includes a socket corresponding to the shape of the male portion of the mechanical joint such that the male and female portions of the mechanical joint are adapted to mate within the side sheet.

6. The coupling mechanism of claim 1, wherein the male portion is coupled with the tail end of the tie bar by at least one of welding and using a mechanical fastener.

7. The coupling mechanism of claim 1, wherein the male portion and the tie bar are manufactured as a unitary component.

8. The coupling mechanism of claim 1, wherein the male portion further defines a through hole in communication with a socket of the female portion, the through hole adapted to receive a mechanical fastener therethrough for attaching the male portion within the socket of the female portion.

9. The coupling mechanism of claim 8, wherein the mechanical fastener extends perpendicular to a length of the tie bar.

10. An aftercooler associated with an engine, the aftercooler comprising:
a tie bar having a tail end;
a side sheet; and
a coupling mechanism adapted to couple the tie bar with the side sheet, the coupling mechanism comprising:
a male portion of a mechanical joint, the male portion coupled with a tail end of the tie bar; and
a female portion of the mechanical joint defined within the side sheet,
wherein the male portion is adapted to mate with the female portion for coupling the tie bar with the side sheet.

11. The aftercooler of claim 10, wherein the mechanical joint is a half blind dovetail joint such that the male portion includes a projecting portion and the female portion includes a socket corresponding to the projecting portion.

12. The aftercooler of claim 10, wherein the male portion of the mechanical joint has at least one of a trapezoidal shape and a circular shape extending from the tail end of the tie bar.

13. The aftercooler of claim 12, wherein female portion formed within the side sheet includes a socket corresponding to the shape of the male portion of the mechanical joint such that the male and female portions of the mechanical joint are adapted to mate within the side sheet.

14. The aftercooler of claim 10, wherein the male portion is coupled with the tail end of the tie bar by at least one of welding and using a mechanical fastener.

15. The aftercooler of claim 10, wherein the male portion and the tie bar are manufactured as a unitary component.

16. The aftercooler of claim 10, wherein the male portion further defines a through hole in communication with a socket of the female portion, the through hole adapted to receive a mechanical fastener therethrough for attaching the male portion within the socket of the female portion.

17. The aftercooler of claim 16, wherein the mechanical fastener extends perpendicular to a length of the tie bar.

18. An engine system comprising:
an engine;
an aftercooler associated with the engine, the aftercooler comprising:
a tie bar having a tail end;
a side sheet; and
a coupling mechanism adapted to couple the tie bar with the side sheet, the coupling mechanism comprising:
a male portion of a mechanical joint, the male portion coupled with a tail end of the tie bar; and
a female portion of the mechanical joint defined within the side sheet,
wherein the male portion is adapted to mate with the female portion for coupling the tie bar with the side sheet.

19. The engine system of claim 18, wherein the male portion is coupled with the tail end of the tie bar by at least one of welding and using a mechanical fastener.

20. The engine system of claim 18, wherein the male portion and the tie bar are manufactured as a unitary component.
